(19) United States
(12) Patent Application Publication
(10) Pub. No.: US 2015/0085420 A1
(43) Pub. Date: Mar. 26, 2015

(54) Conductive Assembly

(71) Applicant: Inpro/Seal LLC, Rock Island, IL (US)

(72) Inventors: Robert A. Tejano, Aledo, IL (US); Dwight A. Vicars, Greer, SC (US)

(21) Appl. No.: 14/496,623

(22) Filed: Sep. 25, 2014

Related U.S. Application Data
(60) Provisional application No. 61/883,060, filed on Sep. 26, 2013.

(51) Int. Cl. H05F 3/02

(52) U.S. Cl. CPC H05F 3/02
USPC 361/220; 29/525.05

(57) ABSTRACT

In one embodiment a conductive assembly may include a casing having a compressed portion and a cylinder. A fiber may be positioned within the casing and the relative position of the fiber with respect to the casing may be secured via engagement between the casing and the fiber at the compressed portion. The compressed portion may be configured as a plurality of alternating vertices and tables and the fiber may extend outward from the casing.

### CROSS-REFERENCE TO RELATED APPLICATIONS

The present utility patent application claims priority from provisional U.S. Pat. App. No. 61/883,060 filed on Sep. 26, 2013, which application is incorporated by reference herein in its entirety.

### FIELD OF THE INVENTION

The present invention relates to an electrical charge dissipating device, and more particularly to a conductive assembly for directing electrostatic charge to ground, which electrostatic charge may be created through the use of rotating equipment.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### AUTHORIZATION PURSUANT TO 37 C.F.R. §1.171(d)

A portion of the disclosure of this patent document may contain material that is subject to copyright and trademark protection. The copyright owner has no objection to the facsimile reproduction by anyone of the patent document or the patent disclosure, as it appears in the Patent and Trademark Office patent file or records, but otherwise reserves all copyrights whatsoever. CDR and Current Diverter Ring are the exclusive trademarks of Inpro/Seal LLC.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limited of its scope, the invention will be described and explained with additional specificity and detail through the use of the accompanying drawings.

FIG. 1A is a perspective view of a first illustrative embodiment of a current diverter ring (GDR).

FIG. 1B is an axial cross section view of the first embodiment of the current diverter ring.

FIG. 2A is a perspective view of a second illustrative embodiment of a CDR.

FIG. 2B is another perspective view of the second embodiment of a CDR with the shaft removed for clarity.

FIG. 2C is an axial, cross-sectional view of second embodiment of a CDR.

FIG. 3A is a perspective view of a third illustrative embodiment of a CDR.

FIG. 3B is another perspective view of the third embodiment of a CDR with e shaft removed for clarity.

FIG. 3C is an axial, cross-sectional view of the third embodiment of a CDR.

FIG. 4 is a perspective view of a first illustrative embodiment of a conductive assembly that may be used with certain embodiments of the CDR.

FIG. 5A is a rear perspective view of a second illustrative embodiment of a conductive assembly that may be used with certain embodiments of the CDR.

FIG. 5B is another rear perspective view of the second illustrative embodiment of a conductive assembly.

FIG. 5C is a front perspective view of the second illustrative embodiment of a conductive assembly.

FIG. 5D is a side view of the second illustrative embodiment of a conductive assembly.

FIG. 5E is an end view of the second illustrative embodiment of a conductive assembly.

FIG. 6A is a perspective view of one illustrative embodiment of a casing that may be used with certain embodiments of the conductive assembly.

FIG. 6B is an end view of the illustrative embodiment of a casing shown in FIG. 6A.

FIG. 6C is a side view of the illustrative embodiment of a casing shown in FIGS. 6A & 6B.

FIG. 7 provides a side view of a third illustrative embodiment of a conductive assembly.

FIG. 8 provides a side view of a fourth illustrative embodiment of a conductive assembly.

FIG. 9 provides a side view of a fifth illustrative embodiment of a conductive assembly.

FIG. 10 provides a side view of a sixth illustrative embodiment of a conductive assembly.

FIG. 11 provides a side view of a seventh illustrative embodiment of a conductive assembly.

### DETAILED DESCRIPTION ELEMENT LISTING

| Description | Element No. |
|---|---|
| Conductive assembly | 10 |
| Contact end | 12 |
| Shaft | 14 |
| Retention end | 16 |
| Fiber | 20 |
| Distal end | 22 |
| Proximal end | 24 |
| Casing | 30 |
| Compressed portion | 32 |
| Vertex | 32a |
| Table | 32b |
| Cylinder | 34 |
| Exterior ramp | 36 |
| Interior ramp | 37 |
| Mounting aperture | 54 |
| Strap | 70 |
| Fastener | 72 |
| Radial CDR | 80 |
| Arc CDR | 80a |
| Arc cut out | 81 |
| Radial channel | 82 |
| Radial channel shelf | 83 |
| Radial exterior surface | 85a |
| Radial interior surface | 85b |
| Conductive assembly | 86 |
| Binder | 86a |
| Contact portion | 86b |
| Plug | 87 |
| Main aperture | 88 |

### Scription

Before the various embodiments of the present invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that phraseology and terminology used herein with reference to device or element orientation (such as, for example, terms like “front”, “back”, “up”, “down”, “to ”, “bottom”, and the like) are only used to simplify description of the present invention, and do not alone indicate or imply that the device or element referred to must have a particular orientation, In addition, terms such as “first”, “second”, and “third” are used herein and in the appended claims for purposes of description and are not intended to indicate or imply relative importance or significance. Additionally, the terms radial CDR 80, arc CDR 80a, and/or CDR may be used interchangeably when referring to generalities of configuration thereof, methods and/or materials of construction, and/or other general features as may the terms conductive assembly 10, 86. Finally, any dimensions, geometries, and/or other physical characteristics described herein are not limiting, but are for illustrative purposes only.

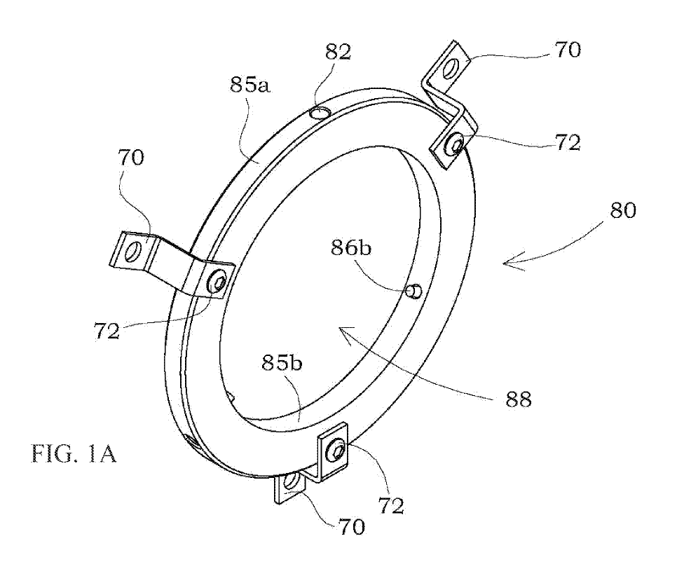

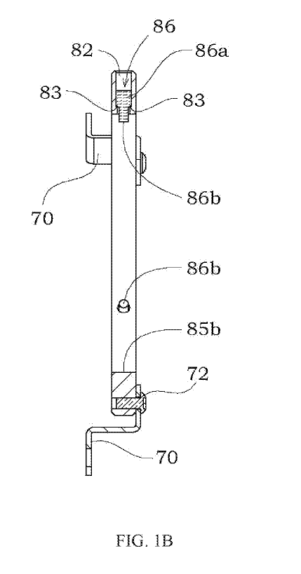

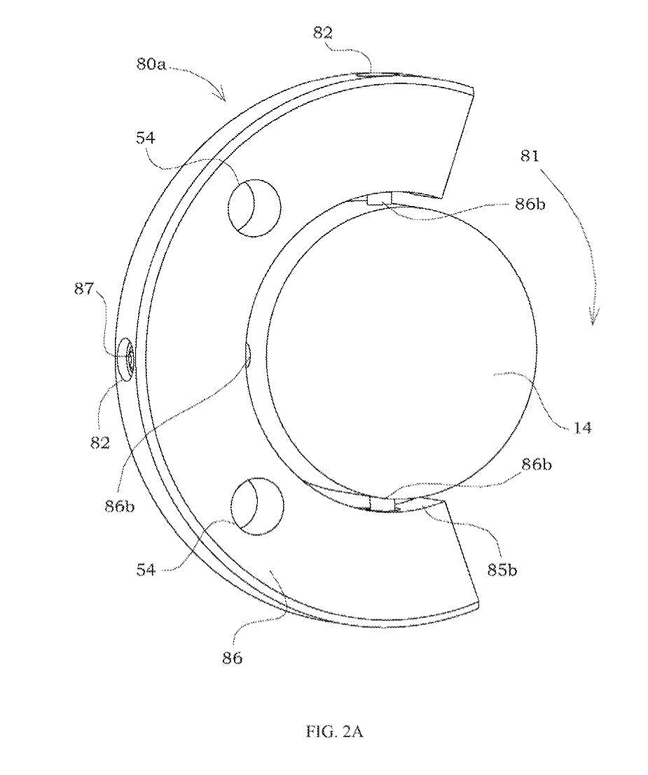

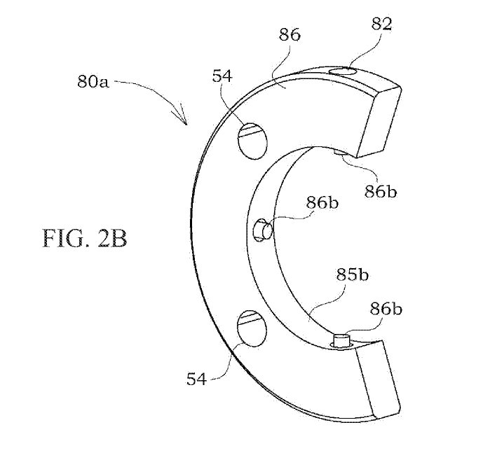

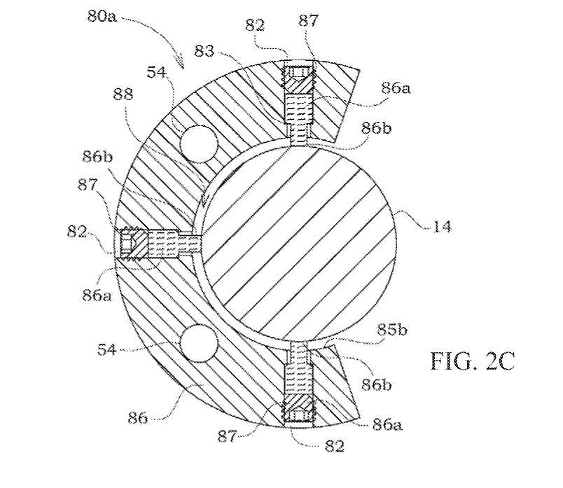

The radial CDR 80, one embodiment of which is shown in FIGS. 1 A & 1B, and/or arc CDR 80a, various embodiments of which are shown in FIGS. 2 & 3, may be press-fit into an aperture in an equipment housing (or other structure from which a shaft 14 extends, not shown), or may be secured to the exterior of the equipment housing using straps 70 and fasteners 72 as describe(in detail below and as shown in the various figures. The CDR 80, 80a may also be secured to an equipment housing via other structures and/or methods, such as chemical adhesion, welding, rivets, or any other structure and/or method suitable for the particular application without limitation. The CDR 80, 80a may also be configured to be engaged with a bearing isolator 10, or integrally formed with a bearing isolator 10, as described in U.S. Pat. No. 8,604,653, which is incorporated by reference herein in its entirety.

### Illustrative Embodiment of a Radial Cdr

A radial CDR 80 is one embodiment of a current dissipating device, an illustrative embodiment of which is shown in FIGS. 1A and B a ring-shaped structure having a main aperture 88 in the center thereof The radial CDR 80 may be mounted to rotational equipment through any structure and/or method without limitation as described above. The embodiment of the radial CDR 80 shown in FIGS. 1A and 1B may include three straps 70 engaged with the radial CDR 80 via fasteners 72. Other fasteners 72 may be used to secure the straps 70 to the rotational equipment, thereby securing the radial CDR 80 to the rotational equipment. In other embodiments of the radial CDR 80, the radial exterior surface 85a of the radial CDR 80 is press-fit into the rotational equipment housing. However, the mounting method for the radial CDR is in no way limiting to the scope of the present disclosure.

The illustrative embodiment of the radial CDR 80 shown herein may include three radial channels 82 extending from the radial exterior surface 85a to the radial interior surface 85b of the radial CDR 80. Each radial channel 82 may include a radial channel shelf 83, which is best shown in FIG. 1B. In the pictured embodiment, the radial channel shelf 83 may be located adjacent the radial interior surface 85b of the radial CDR 80. However, in other embodiments a radial channel shelf 83 may be differently located and/or positioned without limitation. Other numbers and/or configurations of radial channels 82 may be used without limiting the scope of the present disclosure.

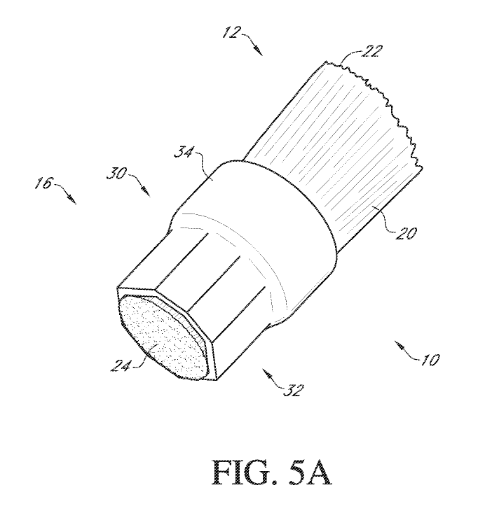

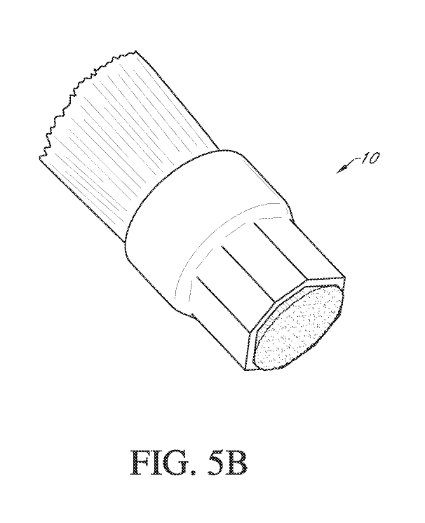

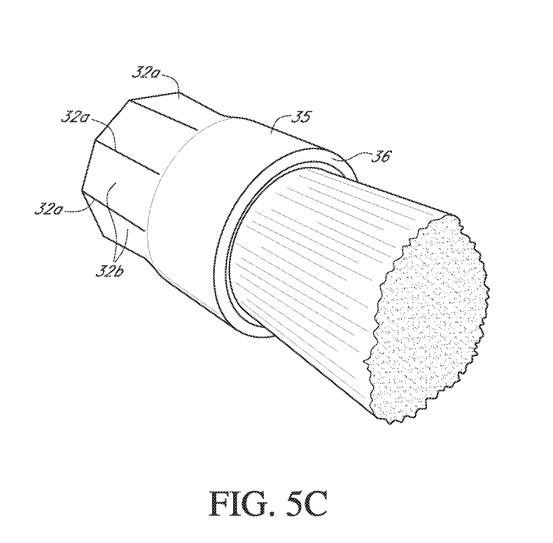

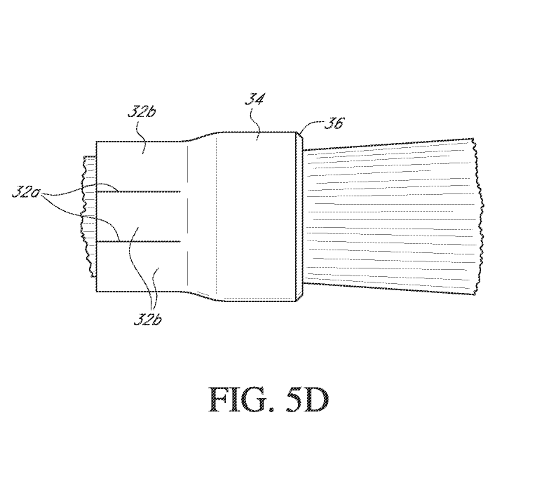

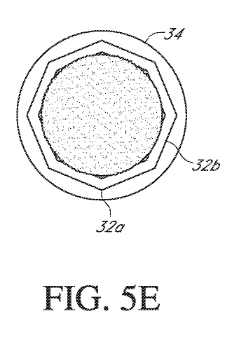

A conductive assembly 86 may be configured to fit within the radial channel 82. One embodiment of a conductive assembly 86 that may be positioned in a radial channel 82 is shown in detail in FIG. 4. This embodiment of a conductive assembly 86 may comprise a binder 86a, which may be primarily located within the radial channel 82, and a contact portion 86b, which may extend radially inward from the radial channel 82. The binder 86a may be formed as any structure that retains the elements of the conductive assembly 86, including but not limited to a chemical adhesive, structural cap or tether, clap, or combinations thereof, Other types of conductive assemblies 86 (such as those shown in FIGS. 5 and 7-11)) may be used with the radial CDR 80 without limitation.

The conductive assemblies 86 in the radial CDR 80 may be configured to be replaceable. That is, once the contact portion 86b of a conductive assembly 86 has been exhausted, or the conductive assembly 86 should otherwise be replaced or not perform adequately, the user may remove the conductive assembly 86 from the radial channel 82 and insert anew conductive assembly 86 therein.

### Illustrative Embodiments of an Arc CDR

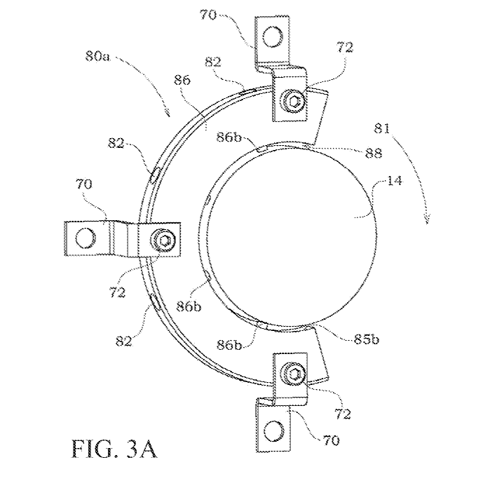

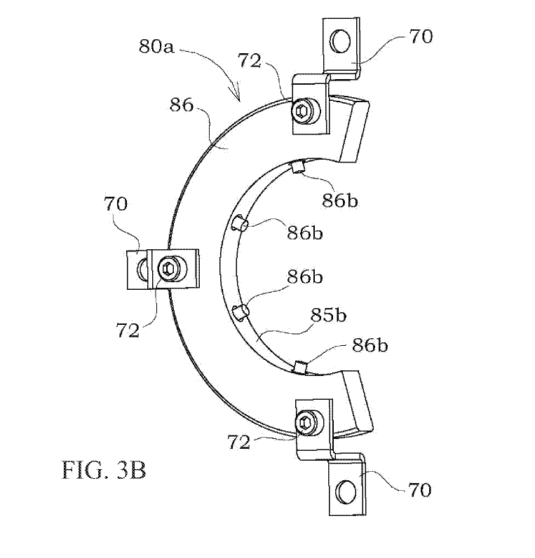

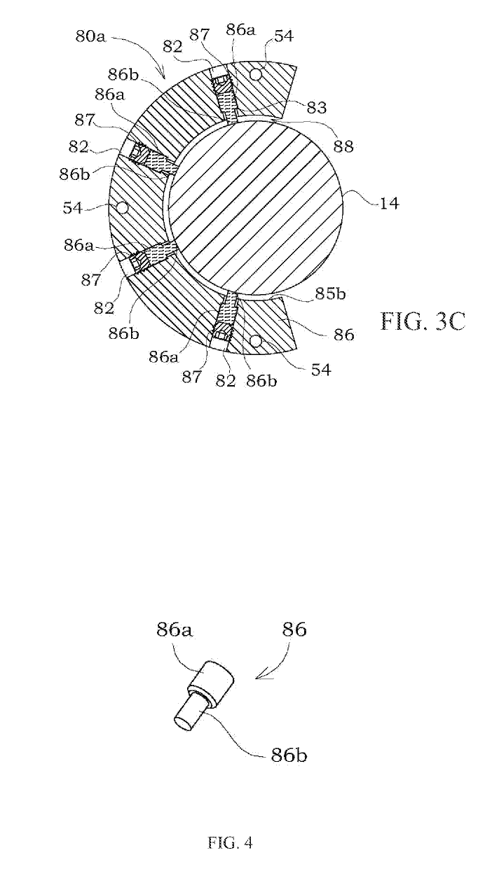

An arc CDR 80a is another embodiment of a current dissipating device and a second embodiment of a CDR. A first embodiment of an arc CDR 80a is shown in FIGS. 2A-2C and may be configured as semi-circular shaped structure that may have a main aperture 88 in the center thereof and an arc cut out 81. FIG. 2A provides a perspective view of the first illustrative embodiment of an arc CDR 80a positioned over a shaft 14. FIG. 2B provides another perspective view of the first embodiment of an arc CDR 80a without a shaft 14 for purposes of clarity. FIG. 2C provides a radial cross-sectional view of the arc CDR 80a shown in FIGS. 2A & 2B. A perspective view of a second embodiment of an arc CDR 80a (which is a third embodiment of a CDR) is shown positioned around a shaft 14 is shown in FIG. 3A. FIG. 3B provides another perspective view of the second embodiment of an arc CDR 80a with the shaft 14 removed. FIG. 3C provides a radial cross-sectional view of the second embodiment of the arc CDR 80a.

The illustrative embodiments of the arc GDR 80a as shown herein may be configured such that they function substantially the same as the radial CDR 80 shown in FIGS. 1A and 1B. However, because the arc CDR 80a may be configured such that it is not a full ring, the arc GDR 80a may be easier to install over certain shafts 14 when compared to certain embodiments of a radial CDR 80 for specific applications. For certain embodiments of the arc CDR 80a it may be beneficial to use a sleeve (not shown), plate (not shown) or other structure to properly position the arc CDR 80a with respect to the shaft 14. It is contemplated that the embodiment of an arc CDR 80a shown in FIGS. 2A-2C may be engaged with the structure (e.g., equipment housing) from which the shaft 14 extends via one or more mounting apertures 54 therein that may cooperate with a fastener 72. It is contemplated that the embodiment of an arc CDR 80a shown in FIGS. 3A-3C may be engaged with the structure equipment housing) from which the shaft 14 extends via. one or more straps 70 in cooperation with one or more fasteners 72. However, any suitable structure and/or method for securing the arc CDR 80a to a structure may be used without limitation as previously described above.

The illustrative embodiments of an arc CDR 80a pictured herein may be configured such that the arc CDR 80a may extend beyond 180 degrees of a circle. More specifically, the illustrative embodiment of the arc CDR 80a may be configured as approximately 200 degrees of a full circle. However, in other embodiments the length of the arc CDR 80a may be greater than 200 degrees of a full circle. In still other embodiments, the length of the arc CDR 80a may be less than 180 degrees of a full circle. Accordingly, the length of an arc CDR 80a in no way limits the scope of the present disclosure.

The illustrative embodiment of an arc CDR 80a shown in FIGS. 2A-2C may include three radial channels 82, which may be configured to extend from the radial exterior surface 85a to the radial interior surface 85b of the arc CDR 80a. Each radial channel 82 may include a radial channel shelf 83, which is best shown in FIG. 2C, In the pictured embodiments, the radial channel shelf 83 may be located adjacent the radial interior surface 85b of the arc CDR 80a. However, in other embodiments a radial channel shelf 83 may be differently located and/or positioned without limitation. Additionally, other numbers and/or configurations of radial channels 82 may be used without limiting the scope of the present disclosure.

The illustrative embodiment of an arc CDR 80a shown in FIGS. 3A-3C may include four radial channels 82, These radial channels 82 may be configured with a radial channel shelf 83 as previously described for the first embodiment of an arc CDR 80a. A conductive assembly 86 may be configured to securely engage a radial channel 82, and a plug 87 may be positioned over the conductive assembly 86 to secure the position of the conductive assembly 86 with respect to the radial channel 82. One embodiment of a conductive assembly 86 that may be used with the illustrative embodiments of an arc CDR 80a is shown in detail in FIG. 4. Other types of conductive assemblies 86 (such as those shown in FIGS. 5 and 7-11) may be used with the arc CDR 80a without limitation. One illustrative embodiment of a plug 87 is threaded and may be configured to cooperate with threads formed in a radial channel 82, as shown in FIG. 2C. Other numbers, configurations, and/or orientations of plugs 87 or other structures and/or methods to secure the position of a conductive assembly 86 with respect to a radial channel 82 may be used with any embodiment of a CDR 80, 80a without limitation.

The conductive assemblies 86 in the arc CDR 80a may be configured to be replaceable. That is, once the contact portion 86b of a conductive assembly 86 has been exhausted, or the conductive assembly 86 should otherwise be replaced, the user may remove the conductive assembly 86 (and/or plug 87 if one is used) from the radial channel 82 and insert a new conductive assembly 86 therein. The number of radial channels 82 formed in an arc CDR 80a in no way limits the scope thereof, and similarly, the number of conductive assemblies engaged therewith in no way limits the scope of an arc CDR 80a.

### Other Illustrative Embodiments of a Conductive Assembly

A second illustrative embodiment of a conductive assembly 10 that may be used with electric charge dissipating devices (e.g., radial CDR 80, arc CDR 80a, etc.) is shown in FIGS. 5A-5E. It is contemplated that this embodiment of a conductive assembly 10 may be easier to replace that other conductive assemblies found in the prior art. The embodiment shown in FIG. 5 generally may include a contact end 12 and a retention end 16. This embodiment may be specifically optimized for use with the radial CDR, 80 and/or arc CDR, 80a without limitation. As such, it is contemplated that the retention end 16 or a portion thereof may generally be engaged with an electrical charge dissipating device (e.g., via insertion into a radial channel 82 in the radial CDR 80 or arc CDR 80a). The contact end 12 may protrude away from the charge dissipating device for contact with another structure (e.g., a shaft 14),

In the illustrative embodiment, a plurality of fibers 20 may be positioned within and retained by a casing 30. The fibers 20 in the illustrative embodiment may be carbon filaments with a generally low electrical impedance. The optimal size and/or number of the fibers 20 will vary from one application to the next, but it is contemplated that many applications will require fibers 20 having a diameter between 0.000001 mm and 20 mm and a length between 1 mm and 100 mm. However, the scope of the present disclosure is in no way limited by the size of the fibers 20 and/or the material used for the construction thereof. One fiber 20 that is suitable for some applications is a Panex 35 Continuous Tow sold by Zoltek Corp. based in St. Louis, Mo. The tensile strength of this material is approximately 4137 MPa, the tensile modulus approximately 242 GPa, the electrical resistivity approximately 0.00155 ohm-cm, the density approximately 1.81 g/cc, the fiber diameter approximately 7.2 microns, and the carbon content is approximately 95%.

As shown, the casing 30 may include a compressed portion 32 and a cylinder 34. The compressed portion 32 may be located generally adjacent the proximal ends 24 of the fibers 20. Specifically, in the second illustrative embodiment of a conductive assembly 10 the end of the casing 30 at the retention end 16 of the conductive assembly 10 and the proximal ends 24 of the fibers 20 may be coterminous. The compressed portion 32 may be configured to have a plurality of tables 32b, which tables 32b may be configured as relatively flat portions. The tables 32b may be separated by vertices 32a. In the second illustrative embodiment, the compressed portion 32 may be formed with eight vertices 32a that may be equally spaced about the periphery of the casing 30, and one table 32b may be positioned between adjacent vertices 32a for a total of eight tables 32b and eight vertices 32a. As best shown in FIG. 5E, such a configuration generally may form a regular octagon. It has been found via testing that this configuration may be optimal for manufacturing multiple conductive assemblies 10 repeatedly, wherein the fibers 20 may be adequately retained within the casing 30. However, in other embodiments of the conductive assembly 10, the spacing between adjacent vertices 32a and/or the number thereof may vary, as may the dimensions of each table 32b and/or number thereof. Accordingly, the scope of the present disclosure is not limited to a compressed portion 32 having eight equally spaced vertices 32a with generally flat tables 32b therebetween, but instead extends to any configuration and/or number of tables 32b and/or vertices 32a without limitation, including but not limited to curved tables 32b, four vertices 32a and four tables 32b, five vertices 32a and five tables 32b, six vertices 32a and six tables 32b, etc.

Generally, the optimal configuration of the compressed portion 32 will vary depending on the application of the conductive assembly 10. It is contemplated that for many applications, at least one design consideration for the conductive assembly 10 will comprise the force required to remove a fiber 20 from the casing 30. This force will at least depend on the length of fiber 20 positioned within the casing 30, any external force applied to the external surface of the compressed portion 32, and/or the configuration of the compressed portion (e.g., dimension, geometry, etc.). Accordingly, the optimal distance that the distal ends 22 of the fibers 20 extend from the cylinder 34 will vary from one application of the conductive assembly 10 to the next, and is therefore in no way limiting to the scope thereof. It is contemplated that for some applications, the optimal distance the distal ends 22 of the fibers 20 extend from the cylinder 34 will be between 0.1 mm and 25 mm. Furthermore, the scope of the present disclosure is in no way limited by the various dimensions and/or configurations described above.

in second illustrative embodiment of a conductive assembly 10 pictured in FIGS. 5A-5E, the fibers 20 may extend from the cylinder 34 by approximately 0.165 inches with a tolerance of +/−0.010 inches; the diameter of the cylinder 34 may be approximately 0.160 inches with a tolerance of +/−0.002 inches; the length of the casing 30 may be approximately 0.170 inches with a tolerance of +0.010 inches and −0.005 inches; the axial length of the compressed portion 32 may be approximately 0.085 inches with a tolerance of +/−0.010 inches; width of the compressed portion 32 (i.e., from one table 32b to the opposing table 32b) may be approximately 0.130 inches +0.003 and −0.001 inches, However, as stated above, these dimensions are in no limiting to the scope of the conductive assembly 10 and are for illustrative purposes only.

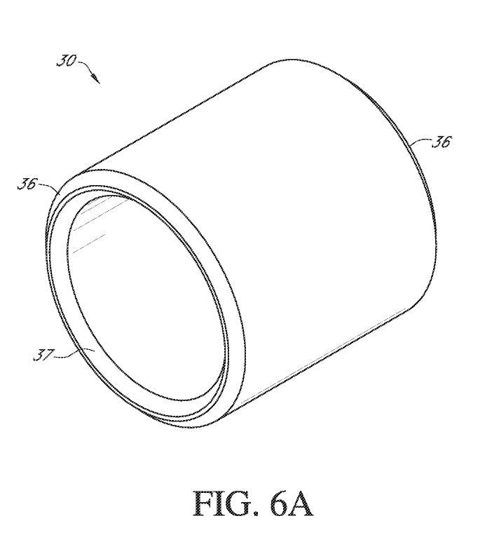

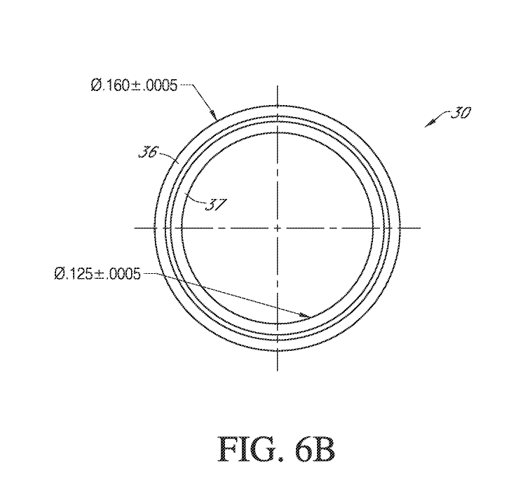

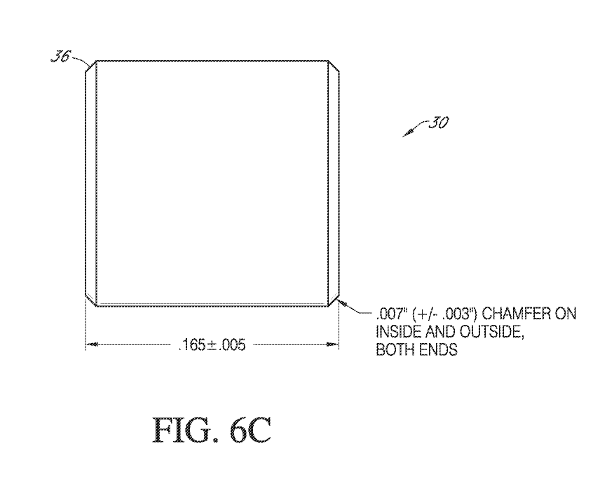

One illustrative embodiment of a casing 30 that may be used with a conductive assembly 10 is shown in FIGS. 6A-6C. It is contemplated that when employing the illustrative embodiment of a casing 30 shown herein to fabricate a conductive assembly 10, a plurality of fibers 20 may be first positioned within the interior bore of the casing 30, and then an external force may be placed on a portion of the exterior of the casing 30 to form the compressed portion 32, and thereby retaining the fibers 20 within the casing 30.

As shown, the casing 30 may include at least one ramp 6, 37. In the illustrative embodiment, the casing 30 may include an exterior ramp 36 and an interior ramp 37 on each end of the casing 30. An exterior ramp 36 may facilitate ease of insertion of the conductive assembly 10 into a radial channel 82. An interior ramp 87 may facilitate eased insertion of the fibers 20 into the central bore of the casing 30. Additionally, the presence of a ramp 36, 37 and configuration thereof may mitigate against inadvertently shearing and/or damaging a fiber 20 during manufacture and/or use of the conductive assembly 10. In the illustrative embodiment, the ramps 36, 37 may be angled at 45 degrees with respect to the axial dimension of the casing 30, but other configurations may be used without limitation. For example, in an embodiment not pictured herein the exterior ramp 36 may be angled at 60 degrees with respect to the axial dimension of the casing 30 and the interior ramp 37 may be angled at 65 degrees with respect thereto. Additionally, the exterior ramp 36 on one end of the casing 30 may be differently configured than the exterior ramp 36 on the opposite end of the casing 30, which is also true for the interior ramps 37. Accordingly, the specific configuration of the ramps 36, 37 in no way limits the scope of the present disclosure.

Additionally, the length of either ramp 36, 37 may vary from one embodiment of the casing to the next. The specific length of any ramp 36, 37 may depend at least upon the radial thickness of the casing 30 and the configuration of the opposing ramp 36, 37 on a given end of the casing 30. Accordingly, the length of any ramp 36, 37 in no way limits the scope of the present disclosure.

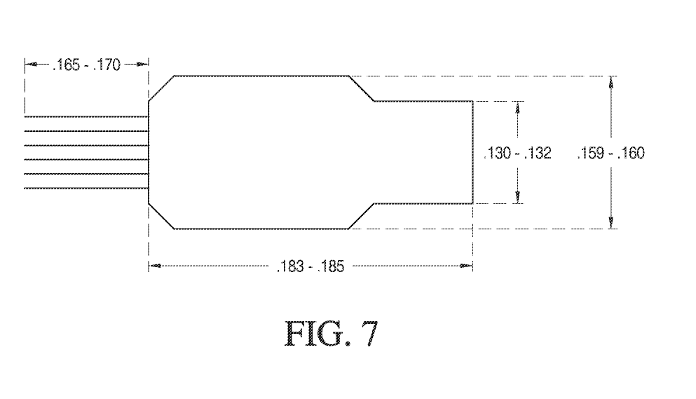

Other embodiments of conductive assemblies 10 are shown in FIGS. 7-11. These embodiments are similar to that shown in FIGS. 5A-5E. However, the embodiments shown in FIGS. 7-11 are configured with different dimensions than the embodiment shown in FIGS. 5A-5E. Again, the optimal dimensions and/or configuration of the conductive assembly 10 and various elements thereof will vary from one application to the next, and are therefore in no way limiting to the scope of the present disclosure.

A third illustrative embodiment of a conductive assembly 10 is pictured in FIG. 7. In this embodiment the fibers 20 may extend from the cylinder 34 by approximately 0.165 to 0.170 inches; the diameter of the cylinder 34 may be approximately 0.160 inches; the length of the casing 30 may be approximately 0.184 inches; the width of the compressed portion 32 (i.e., from one table 32b to the opposing table 32b) may be approximately 0.130 inches. However, as stated above, these dimensions are in no way limiting to the scope of the conductive assembly 10 and are for illustrative purposes only.

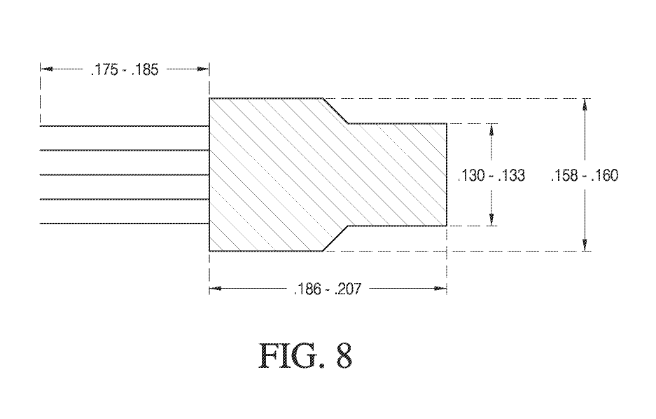

A fourth illustrative embodiment of a conductive assembly 10 is pictured in FIG. 8. In this embodiment the fibers 20 may extend from the cylinder 34 by approximately 0.175 to 0.185 inches; the diameter of the cylinder 34 may be approximately 0.160 inches; the length of the casing 30 may be approximately 0.186 to 0.207 inches; the width of the compressed portion 32 (i.e., from one table 32b to the opposing table 32b) may be approximately 0.130 inches. However, as stated above, these dimensions are in no way limiting to the scope of the conductive assembly 10 and are for illustrative purposes only.

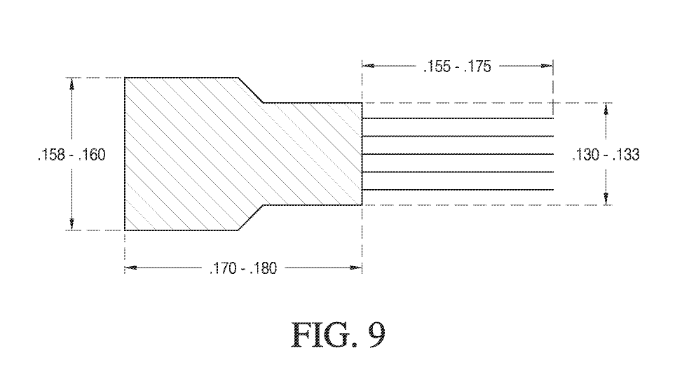

A fifth illustrative embodiment of a conductive assembly 10 is pictured in FIG. 9. in this embodiment the fibers 20 may extend from the cylinder 34 by approximately 0.155 to 0.175 inches; the diameter of the cylinder 34 may be approximately 0.160 inches; the length of the casing 30 may be approximately 0.170 to 0.180 inches; the width of the compressed portion 32 (i.e., from one table 32b to the opposing table 32b) may be approximately 0.130 inches. However, as stated above, these dimensions are in no way limiting to the scope of the conductive assembly 10 and are for illustrative purposes only.

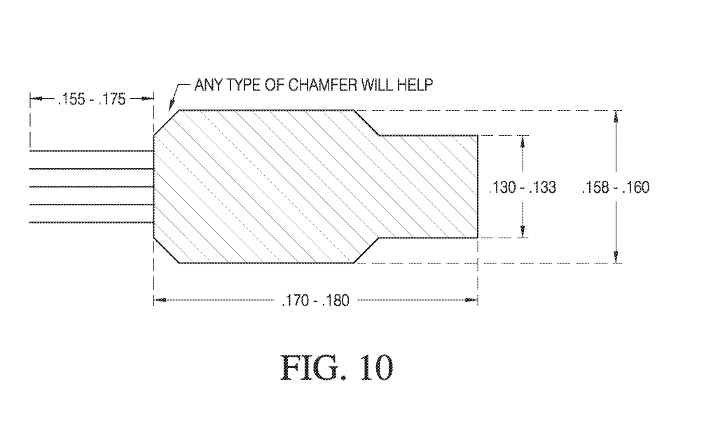

A sixth illustrative embodiment of a conductive assembly 10 is pictured in FIG. 10. In this embodiment the fibers 20 may extend from the cylinder 34 by approximately 0.155 to 0.175 inches; the diameter of the cylinder 34 may be approximately 0.160 inches; the length of the casing 30 may be approximately 0.170 to 0.180 inches; the width of the compressed portion 32 (i.e., from one table 32b to the opposing table 32b) may be approximately 0.130 inches, and the casing 30 may be configured with an exterior ramp 36. However, as stated above, these dimensions are in no way limiting to the scope of the conductive assembly 10 and are for illustrative purposes only.

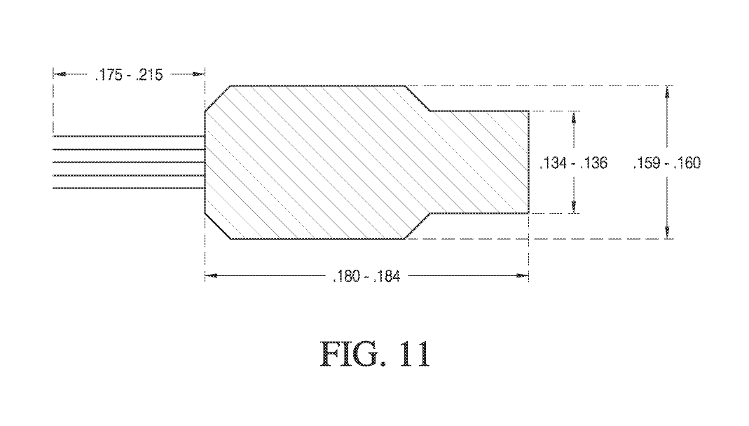

A seventh illustrative embodiment of a conductive assembly 10 is pictured in FIG. 11. In this embodiment the fibers 20 may extend from the cylinder 34 by approximately 0.175 to 0.215 inches; the diameter of the cylinder 34 may be approximately 0.160 inches; the length of the casing 30 may be approximately 0.180 to 0.184 inches; the width of the compressed portion 32 (i.e., from one table 32b to the opposing table 32b) may be approximately 0.134 to 0.136 inches, and the casing 30 may be configured with an exterior ramp 36. However, as stated above, these dimensions are in no way limiting to the scope of the conductive assembly 10 and are for illustrative purposes only.

Although the embodiments of a conductive assembly 10 pictured and described herein may be specifically configured for use with a radial CDR 80 and/or arc CDR 80a, the scope of the conductive assembly 10 is not so limited. The conductive assembly 10 may he used with any type of electrical charge transmitting device, including but not limited to the devices disclosed in U.S. patent application Ser. Nos, 13/710,231; 13/089,017; 12/757,040; 13/114,995; and 13/920,376; and U.S. Pat. No. 7,521,827.

Having described the preferred embodiments, other features of the CDR 80, 80a, and/or conductive assemblies 10, 86 will undoubtedly occur to those versed in the art, as will numerous modifications and alterations in the embodiments as illustrated herein, all of which may be achieved without departing from the spirit and scope of the CDR 80, 80a and/or conductive assembly 10, 86. It should be noted that the CDR 80, 80a and conductive assembly 10, 86 are not limited to the specific embodiments pictured and described herein, but are intended to apply to all similar apparatuses and methods for dissipating and/or conducting an electrical charge from one element to another. Modifications and alterations from the described embodiments will occur to those skilled in the art without departure from the spirit and scope of the CDR 80, 80a and/or conductive assembly 10, 86.

1. A conductive assembly comprising:
a. a casing, said casing comprising:
i. a compressed portion; and
ii. a cylinder;
b. a fiber positioned in said casing, wherein in a first portion of said fiber is secured within said casing at said compressed portion, and wherein a second portion of said fiber extends outward from said cylinder.

2. The conductive assembly according to claim 1 wherein said compressed portion is further defined as comprising a table and a vertex.

3. The conductive assembly according to claim 2 wherein said compressed portion further comprises a plurality of tables and vertexes in an alternating arrangement.

4. The conductive assembly according to claim 1 wherein a terminal end of said compressed portion further comprises an exterior ramp.

5. The conductive assembly according to claim 1 wherein a terminal end of said compressed portion further comprises an interior ramp.

6. The conductive assembly according to claim 1 wherein a terminal end of said cylinder further comprises an exterior ramp.

7. The conductive assembly according to claim 1 wherein a terminal end of said cylinder further comprises an interior ramp.

8. The conductive assembly according to claim 1 further comprising a plurality of fibers, wherein a first portion of each said fiber is secured within said casing at said compressed portion, and wherein a second portion of each said fiber extends outward from said cylinder.

9. The conductive assembly according to claim 3 wherein said plurality of tables and said plurality of vertices is further defined as eight.

10. The conductive assembly according to claim 9 wherein said compressed portion is further defined as being configured substantially as a normal octagon.

11. The conductive assembly according to claim 10 wherein said compressed portion is further defined as extending along approximately half the length of said casing.

12. The conductive assembly according to claim 11 wherein a first end of said plurality of fibers is coterminous with a terminal end of said casing at said compressed portion.

13. The conductive assembly according to claim 12 wherein a second end of said plurality of fibers extends from said cylinder by a length approximately equal to the length of said casing.

14. A method of retaining a plurality of fibers in a casing, said method comprising the steps of:
a. positioning said plurality of fibers within said casing;
b. applying a radially inward three to a portion of said casing to create a compressed portion;
c. configuring said compressed portion as a plurality of vertexes and tables;
d. arranging said plurality of vertexes and said plurality of tables such that each said vertex is adjacent two said tables and such that each said table is adjacent two said vertexes; and
e. securing the position of said plurality of fibers with respect to said casing via the engagement between said plurality of fibers and said compressed portion.

15. The method according to claim 14 wherein said plurality of vertexes is further defined as including eight vertexes and wherein said plurality of tables is further defined as including eight tables.

16. The method according to claim 15 wherein said casing further comprises a cylinder, and wherein a first end of said plurality of fibers extends outward from said cylinder.
